(19) United States
(12) Patent Application Publication
(10) Pub. No.: US 2025/0005577 A1
(43) Pub. Date: Jan. 2, 2025

(54) FAMILIARITY INDEX FOR USER AUTHENTICATION

(71) Applicant: Wells Fargo Bank, N.A., San Francisco, CA (US)

(72) Inventors: Vamshi Krishnam Raju Bollepally, Hyderabad (IN); Sathish Parameshwara, Bangalore (IN)

(21) Appl. No.: 17/817,553

(22) Filed: Aug. 4, 2022

(51) Int. Cl. G06Q 20/40; G06Q 30/00

(52) U.S. Cl. CPC G06Q 20/40145; G06Q 30/016

(57) ABSTRACT

A computer system may use a familiarity index to evaluate incoming audio or video calls concerning a proposed transaction. The familiarity index may include information related to the caller, such as location, user device information, and information extracted from onboarding calls. The familiarity index may be resistant to deep fake technology, and the information extracted from onboarding calls may include accent, word choice, and/or facial expression information that is not typically emulated with deep fake technology.

### TECHNICAL FIELD

The disclosure relates to computer systems, and more specifically, to security systems for call-based transactions.

### BACKGROUND

A contact center is a facility configured to handle incoming voice calls from customers or potential customers of a business or organization. One function of the contact center is to handle customer service inquiries focused on customer accounts with the business, i.e., servicing existing accounts and opening new accounts. Although many customer service inquiries can be handled through online interactions (e.g., via websites, email, or mobile applications), for some businesses, a contact center may be regarded as necessary. Customers of banks, for example, may prefer to speak to a live person when resolving service issues. A contact center may include one or more interactive voice response (IVR) systems and one or more agent desktop systems used by a number of human agents that are representatives of the business.

### SUMMARY

In general, this disclosure describes a computer system configured to develop and use a familiarity index to evaluate incoming audio or video calls concerning a proposed transaction. The incoming call may be a videotelephony or videoconferencing call, a Voice over Internet Protocol (VOIP) call, a public switched telephone network (PSTN) call, or a call using any other suitable protocol. The familiarity index is unique to an authorized user and may include information related to the user, such as location, user device information, and information extracted from initial call(s) to initialize the familiarity index of the user. The familiarity index includes information that may be resistant to deep fake technology. For example, the information extracted from onboarding call(s) used to develop the familiarity index of the user may include accent, word choice, and/or facial expression information of the user, which are elements that deep fake technology is not typically capable of emulating. The computer system disclosed herein analyzes the incoming audio or video call to identify elements related to the caller that may be matched with the familiarity index of the authorized user. The identified elements of the incoming call may include location, user device information, accent, word choice, and/or facial expression information of the caller. The computer system may match the elements of the call with the familiarity index information to determine whether the caller is the authorized user and/or whether to block the proposed transaction.

In one example, this disclosure is directed to a computer-implemented method comprising receiving an audio or video call at a computing system from a caller at a user device, the audio or video call related to a proposed transaction; obtaining, at the computing system, a familiarity index resistant to deep fake technology, the familiarity index including information concerning an authorized user; extracting, at the computing system, one or more elements from the audio or video call from the caller, and automatically evaluating, at the computing system, the one or more elements extracted from the audio or video call from the caller with the familiarity index of the authorized user to determine whether to block the proposed transaction.

In another example, this disclosure is directed to a computing system comprising, a memory; and one or more processors in communication with the memory and configured to receive an audio or video call from a caller at a user device, the audio or video call related to a proposed transaction; obtain a familiarity index resistant to deep fake technology, the familiarity index including information concerning an authorized user; extract one or more elements from the audio or video call from the caller, and automatically evaluate the one or more elements extracted from the audio or video call from the caller with the familiarity index of the authorized user to determine whether to block the proposed transaction.

In a further example, this disclosure is directed to a non-transitory computer readable medium including instructions that when executed cause one or more processors to receive an audio or video call from a caller at a user device, the audio or video call related to a proposed transaction; obtain a familiarity index resistant to deep fake technology, the familiarity index including information concerning an authorized user; extract one or more elements from the audio or video call from the caller, and automatically evaluate the one or more elements extracted from the audio or video call from the caller with the familiarity index of the authorized user to determine whether to block the proposed transaction.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example contact center that includes a familiarity index system in accordance with the techniques of this disclosure.

FIG. 2 is a block diagram illustrating an example computing device of the familiarity index system within the contact center from FIG. 1, in accordance with the techniques of this disclosure.

FIG. 3 is a block diagram illustrating an exemplary comparison using a stored familiarity index.

FIG. 4 is a flowchart illustrating an example operation of a computing device of a familiarity index system, in accordance with the techniques of this disclosure.

### DETAILED DESCRIPTION

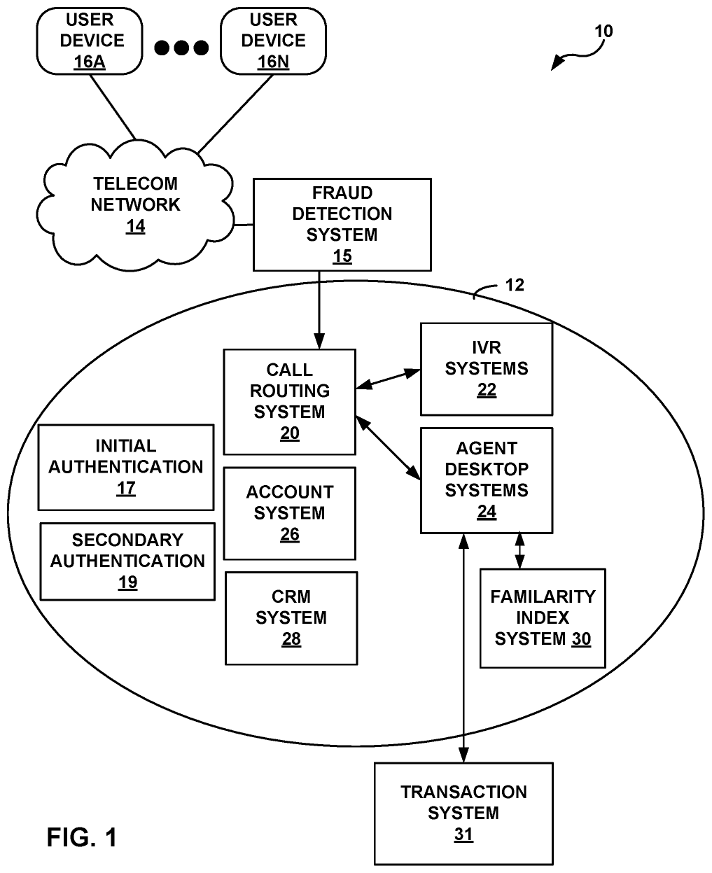

FIG. 1 is a block diagram illustrating an example contact center 12 within a network 10 that includes a familiarity index system 30, in accordance with the techniques of this disclosure. As illustrated in FIG. 1, network 10 includes one or more user devices 16A-16N (collectively “user devices 16”) in communication with contact center 12 via a connection network 14.

Contact center 12 is a facility configured to handle incoming voice and video calls from user devices 16 operated by users that may be customers or potential customers of a business or organization. In some cases, contact center 12 may be referred to as a call center. Contact center 12 includes several disparate computing systems configured to handle customer service inquiries focused on customer accounts with the business, i.e., servicing existing accounts and opening new accounts. In some examples described in this disclosure, contact center 12 may be a contact center of a bank or other financial institution. Contact center 12 may be especially useful for those customers that prefer to speak to a live person when resolving service issues or that feel more comfortable sharing personal information over a voice channel than an online channel (e.g., website, email, or mobile application). Contact center 12 may also provide certain services that may not be available via online channels, such as opening new accounts with the business or organization.

User devices 16 may be any suitable communication or computing device, such as a conventional or landline phone, or a mobile, non-mobile, wearable, and/or non-wearable computing device capable of communicating over connection network 14. One or more of user devices 16 may support communication services over packet-switched networks, e.g., the public Internet, including Voice over Internet Protocol (VOIP). One or more of user devices 16 may also support communication services over circuit-switched networks, e.g., the public switched telephone network (PSTN). The user devices 16 may use video telephony/video conferencing calls over a packet-switched network, such as Zoom or Microsoft Teams video calls.

Each of user devices 16 is operated by a caller that may be a customer or a potential customer of the business or organization that provides contact center 12. In the case of a business or corporate customer, the user may be a representative of the business or corporate customer. In some examples, the user may be a non-human robo-caller utilized by a fraudster or bad actor. In other examples, the user may be a human fraudster or bad actor, such as a caller using deepfake technologies discussed below. In general, each of user devices 16 may represent a landline phone, a conventional mobile phone, a smartphone, a tablet computer, a computerized watch, a computerized glove or gloves, a personal digital assistant, a virtual assistant, a gaming system, a media player, an e-book reader, a television or television platform, a bicycle, automobile, or navigation, information and/or entertainment system for a bicycle, automobile or other vehicle, a laptop or notebook computer, a desktop computer, or any other type of wearable, non-wearable, mobile, or non-mobile computing device that may perform operations in accordance with one or more aspects of the present disclosure.

In cases where the user is a fraudster, the user may attempt to deceive contact center 12 into revealing information relating to one or more accounts associated with one or more customers of the business or organization that provides contact center 12. A fraudulent user may use at least one of user devices 16 to call contact center 12, and the user may attempt to pass as a legitimate customer. In some examples, the user may attempt to convince contact center 12 into changing an account password or opening a new account. In other examples, the user may endeavor to obtain account numbers, account balances, PIN numbers, or the like from contact center 12. It may be beneficial to identify the call as fraudulent in real-time as the user is interacting with contact center 12 in order to apply a variety of interdiction schemes to the call in an attempt to gather more information about the fraudulent caller while limiting the exposure of customer accounts to the fraudulent caller.

Connection network 14 may be a computer network (e.g., a wide area network (WAN), such as the Internet, a local area network (LAN), or a virtual private network (VPN)), a telephone network (e.g., the PSTN or a wireless network), or another wired or wireless communication network. Although illustrated as a single entity, connection network 14 may include a combination of multiple networks.

Contact center 12 may include a centralized or distributed network of disparate computing systems made up of interconnected desktop computers, laptops, workstations, wireless devices, network-ready appliances, file servers, print servers, or other computing devices. For example, contact center 12 may include one or more data centers including a plurality of servers configured to provide account services interconnected with a plurality of databases and other storage facilities in which customer credentials, customer profiles, and customer accounts are stored.

In the example of FIG. 1, contact center 12 includes systems in which a customer may interact, including one or more interactive voice response (IVR) systems 22, one or more agent desktop systems 24 used by a number of human agents that are representatives of the business or organization, and a customer relationship management (CRM) system 28. These systems may be third-party vendor products used by the business or organization to interact with its customers. Contact center 12 also may include call routing system 20. In this example, call routing system 20 may be propriety tools of the business or organization to facilitate the functions of contact center 12, including collecting, storing, and maintaining data used by contact center 12. In addition, contact center 12 interacts with a fraud detection system 15 which may be a third-party fraud detection system, which may be included in contact center 12 itself or may be administered by a third-party network (not shown). The architecture of contact center 12 illustrated in FIG. 1 is shown for exemplary purposes only and should not be limited to this architecture. In other examples, contact center 12 may include more, fewer, or different computing systems configured to handle customer service inquiries.

In the example of FIG. 1, one of user devices 16, e.g., user device 16A, may initiate a call to contact center 12 of a bank in response to input from an operator of user device 16A. User device 16A outputs a signal over connection network 14. Fraud detection system 15 may operate as a gateway to contact center 12 by providing an initial determination of whether an inbound call is fraudulent. For example, fraud detection system 15 may compare markers, e.g., phoneprints or voiceprints, for the inbound call to known fraudsters, and provide risk information to contact center 12. In some examples, fraud detection system 15 may be implemented using fraud detection solutions for call centers available through Pindrop®. Fraud detection system 15 may provide a risk score or other indication of potentially fraudulent intent for each inbound call to contact center 12. In the case where the inbound call is identified as fraudulent by the fraud detection system 15, the inbound call may be dropped prior to entering contact center 12.

In other cases, where the inbound call is not identified as fraudulent by fraud detection system 15, call routing system 20 of contact center 12 receives the inbound call from connection network 14 and determines whether to route the inbound call to one of IVR systems 22 or one of agent desktop systems 24. In some examples, call routing system 20 may be implemented using call routing solutions available through Genesys Telecommunications Laboratories. In an example where user device 16A requests to speak with a human agent or selects a service that can only be performed by a human agent, call routing system 20 routes the call to one of agent desktop systems 24, thereby enabling a user of user device 16A and a human agent at the one of agent desktop systems 24 to engage in a voice communication session. In an example where user device 16A selects a service for which an IVR program is available, call routing system 20 routes the call to the appropriate one of IVR systems 22, thereby enabling the user of user device 16A to interact with the IVR program.

Initial authentication of the user operating user device 16A may be performed by an initial authentication system 17, or any of the human agents at agent desktop systems 24. As one example, the initial authentication system 17 may issue authentication challenges to the operator of user device 16A during the call, store the responses received from the operator via user device 16A, and, based on the responses, make a determination about whether the operator of user device 16A is authenticated or issue additional authentication challenges. As an alternative example, a human agent at one of agent desktop systems 24 may issue authentication challenges to the operator of user device 16A during the voice communication session and, upon hearing the response of the operator of user device 16A, the human agent may make a determination about whether the operator of user device 16A is authenticated or issue additional authentication challenges. In any of the previous examples, the authentication determination may be based on customer credentials accessible from account system 26 and/or CRM system 28.

Once the operator of user device 16A is authenticated as a customer of the business or organization, one or more of IVR systems 22 and/or the human agents at agent desktop systems 24 may process account service requests received from the customer via user device 16A. In the example of a bank or other financial institution, account service requests may include account balance inquiries, most recent transaction inquiries, money transfers, opening or closing accounts, updating or resetting security credentials, changing or rebalancing investment funds, or the like. IVR systems 22 and the human agents at agent desktop systems 24 may process the account service requests by accessing customer accounts via account system 26 and customer profiles via CRM system 28.

IVR systems 22 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, IVR systems 22 represent cloud computing systems, server farms, and/or server clusters (or portions thereof) that provide services to client devices and other devices or systems. In other examples, IVR systems 22 may represent or be implemented through one or more virtualized compute instances (e.g., virtual machines, containers) of a data center, cloud computing system, server farm, and/or server cluster. IVR systems 22 may communicate with external systems via one or more networks (e.g., contact center 12). In some examples, IVR systems 22 may use network interfaces (such as Ethernet interfaces, optical transceivers, radio frequency (RF) transceivers, Wi-Fi or Bluetooth radios, or the like), telephony interfaces, or any other type of device that can send and receive information to wirelessly communicate with external systems, e.g., call routing system 20 of contact center 12.

IVR systems 22 may host IVR programs used to perform customer service functions for calls into contact center 12, such as authentication, retrieving customer account information, retrieving the last several transactions performed using a specific account, initiating a fund transfer, changing account settings, resetting a PIN or other security credentials, or the like. IVR systems 22 may manage the order in which input prompts are presented to a caller of an inbound call to facilitate the customer service functions provided by the IVR programs. The order in which input prompts are presented to the caller may be based on an IVR input prompt tree and a caller's response to one or more input prompts. The one or more or more input prompts may include one or more requests for information and/or one or more telephony menus, with each telephony menu having one or more different input options (e.g., press “1” for English or press “2” for Spanish would be a telephony menu having two input options). Each telephony menu may include one or more telephony sub-menus. IVR systems 22 may be configured to receive input information from one or more user devices 16 and process the input information. Processing input information received from one or more user devices 16 may result in one or more results. For example, IVR systems 22 may provide one or more subsequent input prompts, may initiate a call transfer, or perform any other action based on the input information.

Agent desktop system 24 may interact with transaction system 31 of the bank. Transaction system 31 may handle transactions including transfers, withdrawals, loans, purchases, deposits and the like. For example, an agent at an agent desktop system 24 may initiate transfers or open an account at the transaction system 31 for a customer as requested by the customer in a transaction request.

According to the techniques described in this disclosure, familiarity index system 30 may be used to compare elements of a call with a stored familiarity index for an authorized user. The familiarity index may be resistant to deep fake technology. Familiarity index system 30 may receive an audio or video call related to a proposed transaction. The familiarity index system 30 may extract one or more elements from the audio or video call from the caller. The familiarity index system 30 may automatically evaluate the one or more elements extracted from the audio or video call from the caller with the familiarity index of the authorized user to determine whether to block the proposed transaction. A communication session between the user device 16 and an agent computing system 24 may be initiated and the familiarity index may be applied to the call during the communication session.

The familiarity index for an authorized user can be produced and stored for an authorized user after authenticating the authorized user. The familiarity index may include elements extracted from previous calls with authorized users and other historical information. The extracted information for the familiarity index may use the same categories and/or be produced with the same or similar machine learning models as the information later extracted from calls associated with proposed transactions. If the call associated with the proposed transaction is authenticated, the familiarity index system 30 may update the familiarity index with the machine learning models using data extracted from the call.

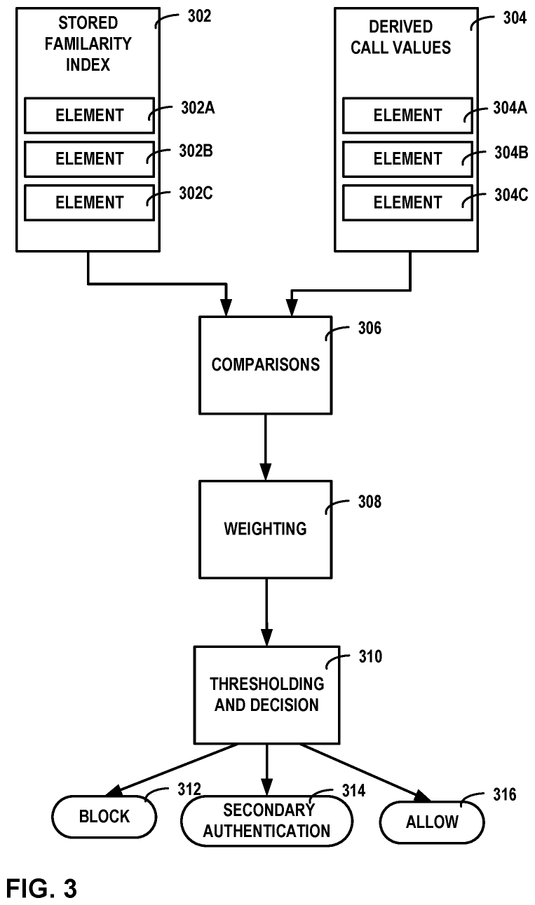

The familiarity index may include features that allow a caller to be authenticated. The evaluating of the caller may include determining whether the call includes features that match the elements of the familiarity index of the authorized user. The evaluating may include calculating a weighted match of the familiarity index with the one or more elements of the audio or video call and comparing the weighted match to a threshold as shown in FIG. 3 discussed below.

Agent desktop system 24 within a contact center 12 may be instructed whether to block or not transmit the transaction request to the transaction system 31 of a bank. For example, a proposed transaction may be blocked as a result of the automatically evaluating by instructing the agent desktop system 24 or a routing system within the contact center 12 to block or not transmit a transaction request to a transaction system 31. Alternately, the proposed transaction may be allowed as a result of the automatically evaluating by instructing an agent desktop system 24 or a routing system within a contact center 12 to transmit a transaction request to a transaction system 31.

Alternately, a secondary authentication process at secondary authentication unit 19 for the caller can be initiated as a result of the automatically evaluating. As one example, the secondary authentication system 19 may issue authentication challenges to the caller and based on the responses, make a determination about whether the caller is authenticated or issue additional authentication challenges.

The computer system may receive calls from multiple additional users, each additional user having an individual familiarity index and may assess each of the multiple additional calls from the multiple additional users with the individual familiarity index for each additional user. In one embodiment, computing system receives additional calls from multiple additional callers, each additional caller having an associated individual familiarity index. One or more elements from the additional calls may be extracted. The one or more elements extracted from the additional calls may be automatically evaluated with the individual familiarity indexes to determine whether to block proposed transactions associated with the additional callers.

The computer system may authenticate the user before the receiving step and initiate a communication session with an agent. The computer system may apply the familiarity index to the call during the communication session. The familiarity index may be generated prior to receiving the audio or video call.

The operation and/or decision making of the familiarity index system 30 may also depend on the proposed transaction. For example, the familiar index system may not be triggered for routine or low-level transactions and only used for high value or otherwise unusual transactions. For example, transactions over a certain value may trigger a higher level of scrutiny by the familiarity index system 30. Further, transactions below another value may trigger a lower level of scrutiny by the familiarity index system 30.

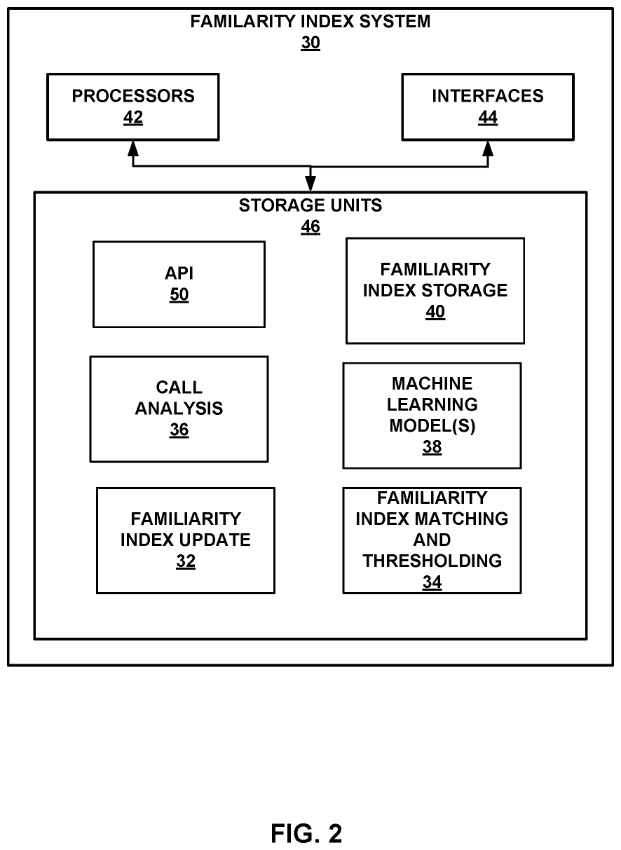

FIG. 2 is a block diagram illustrating an example familiarity index system 30 within a contact center, in accordance with the techniques of this disclosure. One or more aspects of familiarity index system 30 of FIG. 2 may be described within the context of contact center 12 of FIG. 1.

Familiarity index system 30 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, familiarity index system 30 represents a cloud computing system, server farm, and/or server cluster (or portion thereof) that provides services to client devices and other devices or systems. In other examples, familiarity index system 30 may represent or be implemented through one or more virtualized compute instances (e.g., virtual machines, containers) of a data center, cloud computing system, server farm, and/or server cluster.

According to the techniques described in this disclosure, familiarity index system 30 uses individualized familiarity indexes to evaluate audio and video calls. Familiarity index system 30 may store and update familiarity indexes in familiarity index storage 40. Familiarity index system 30 may have an individualized familiarity index for each user. Familiarity index system 30 may use elements that are resistant to deep fake technology. For example, the familiarity index may include elements extracted from an initial authenticated audio or video call. The elements may include voice accent, word choice, and/or facial expression. The familiarity index may also include information related to the user device, such as a media access control (MAC) address or user location as determined by a global navigation satellite system (GNSS), such as the Global Positioning System (GPS).

When contact center 12 receives an audio or video call and a communication session is set up with the agent desktop system 24, call analysis unit 36 in the familiarity index system 30 may analyze the call to extract elements to be compared to the familiarity index. Call analysis unit 36 may use machine learning models 38 to extract elements. For example, machine learning models 38 may create embeddings or output values for extracted elements. The familiarity index system 30 may compare the extracted elements to elements of the familiarity index in the familiarity index matching and thresholding unit 34. As a result of the comparisons, the familiarity index system 30 may compare match results to a threshold. A high match value may indicate that a proposed transaction can proceed; a low match may result in the transaction being blocked, and an intermediate value may result in an additional authentication operation in secondary authentication unit 19.

The call analysis unit 36 may do a call analysis while a call is ongoing before a transaction is completed. The familiarity index system 30 may provide the results of the familiarity index matching to agents through the agent desktop system 24, and an agent may then use this information to obtain additional information from the caller. For example, as the familiarity index system 30 produces the matches, partial match information may be provided at the agent desktop system 24 may be used to send instructions or prompts to the agent desktop system 24. For example, the partial match information may be used to prompt the agent to ask additional questions to obtain further input from the user which may also be analyzed using call analysis unit 36.

Familiarity index update unit 32 can be used to update the familiarity index after a call. For example, the extracted elements from the call can be added to or combined with the familiarity index after the call has been authenticated to improve the familiarity index for a user.

An advantage of the present system is that it may avoid the problem of deepfakes. Deepfakes replace a person in an image, video, or voice call with a mimicked image or voice. Deepfakes use powerful techniques from machine learning and artificial intelligence to manipulate or generate visual and audio content that deceives listeners or viewers. Deepfakes are often created using machine learning methods that train generative neural network architectures, such as autoencoders, or generative adversarial networks (GANs). Deepfake technology has become increasingly popular and convincing in recent years. A potential problem is that fraudsters may use deepfake technology to do fraudulent transactions with audio and video calls. For example, in 2021, a Hong Kong bank manager received a call from a deepfake mimicked voice that he thought be recognized from previous calls which persuaded him to authorize fraudulent transfers in the amount of 35 million dollars. Such deepfake technology may often fool traditional authentication efforts such as facial feature matching systems. The familiarity index may have elements that are resistant to deepfake technology and are thus not easily emulated by the deepfake technology. These elements may include accent, word choice, or facial expressions.

Machine learning models 38 may be used to extract information from the calls and to create elements of the familiarity index for users. Machine learning models 38 may be trained using a training process to create data-specific models. The training process may implement one or more training data sets to create the models. After the training, the created models may be capable of determining an output data set based on an input data set. A computing system may train the machine learning models 38 of the familiarity index system 30 based on a set of labeled training data related to a plurality of customer communications in one or more memories or storage systems within the organization network.

Machine learning models 38 may include a function (e.g., a machine learning algorithm) configured to be executed by processors 42. The function may include nodes, layers, and connections, and the function may be represented by equations having a plurality of variables and a plurality of coefficients.

Machine learning algorithms, such as the function of machine learning models 38, may be trained using a training process to create data-specific models, such as machine learning models 38 based on training data. After the training process, the created model may be capable of determining an output data set based on an input data set. The training process may implement a set of training data to create the model. A training unit may periodically (e.g., monthly, bi-monthly, yearly, or the like) re-train machine learning models 38 based on an updated set of training data.

The familiarity index may be generated using a machine learning model based on historical interactions between the authorized user and the computing system. For example, information related to an authorized user, such as location, user device information, and information extracted from initial call(s) to initialize the familiarity index of the user.

This familiarity index may be updated using the machine learning model after the audio or video call is terminated. One or more elements from audio or video calls extracted using the machine learning model may include voice accent information of the user or facial expression information of the users.

Machine learning models 38 may include an emotional expression determination machine learning model, an accent determination machine learning model, a word choice machine learning model, and/or an element weight machine learning model.

The emotional expression determination machine learning model may be a convolutional neural network (CNN) that processes images from a video call to determine emotional expression values. Images labeled with emotional states as determined by annotators may be used to train such an emotional expression determination machine learning model. The emotional expression values or a series of emotional expression values output by the emotional expression determination machine learning model may then be used to create an element of a familiarity index and/or to create an element of the derived call values.

An accent determination machine learning model may be implemented using speech recognition software to determine accent values. Speech clips labeled with accent information as determined by annotators may be used to train such an accent determination machine learning model. The accent value output by the accent determination machine learning model may then be used to create an element of familiarity index and/or to create an element of the derived call values.

A word choice machine learning model may transcribe the user call to get word choice information. For example, a CNN may use audio spectrograms to produce a transcript. Training speech labeled with its associated transcript may be used to train such a CNN. The transcript of the call may then be analyzed in an additional machine learning model to determine a word choice information. The word choice information may then be used to create an element of familiarity index and/or to create an element of the derived call values.

Additional call analysis may also be done to create an element of familiarity index and/or to create an element of the derived call values. For example, the additional call analysis may rely on user device identifiers such as a media access control (MAC) address or user location, such as that as determined by a global navigation satellite system (GNSS) or an Internet Protocol (IP) address location.

As shown in the example of FIG. 2, familiarity index system 30 includes one or more processors 42, one or more interfaces 44, and storage units 46. Familiarity index system 30 may also include familiarity index update unit 32, familiarity index matching and thresholding unit 34, call analysis unit 36, and machine learning models 38. which may be implemented as program instructions and/or data stored in storage units 46 and executable by processors 42 or implemented as one or more hardware units or devices of familiarity index system 30. Storage units 46 of familiarity index system 30 may also store an operating system (not shown) executable by processors 42 to control the operation of components of familiarity index system 30. The components, units or modules of familiarity index system 30 may be coupled (physically, communicatively, and/or operatively) using communication channels for inter-component communications. In some examples, the communication channels may include a system bus, a network connection, an inter-process communication data structure, or any other method for communicating data.

Processors 42, in one example, may comprise one or more processors configured to implement functionality and/or process instructions for execution within the familiarity index system 30. For example, processors 42 may be capable of processing instructions stored by storage units 46. Processors 42 may include, for example, microprocessors, digital signal processors (DSPs), application specific integrated circuits (ASICs), field-programmable gate arrays (FPGAs), or equivalent discrete or integrated logic circuitry, or a combination of any of the foregoing devices or circuitry.

Storage units 46 may be configured to store information within familiarity index system 30 during operation. Storage units 46 may include a computer-readable storage medium or computer-readable storage device. In some examples, storage units 46 include one or more of a short-term memory or a long-term memory. Storage units 46 may include, for example, random access memories (RAM), dynamic random-access memories (DRAM), static random-access memories (SRAM), magnetic discs, optical discs, flash memories, or forms of electrically programmable memories (EPROM) or electrically erasable and programmable memories (EEPROM). In some examples, storage units 46 are used to store program instructions for execution by processors 42. Storage units 46 may be used by software or applications running on familiarity index system 30 to temporarily store information during program execution.

Familiarity index system 30 may use interfaces 44 to communicate with external systems via one or more networks, e.g., contact center 12 of FIG. 1. Interfaces 44 may be network interfaces (such as Ethernet interfaces, optical transceivers, radio frequency (RF) transceivers, Wi-Fi or Bluetooth radios, or the like), telephony interfaces, or any other type of devices that may send and receive information. In some examples, familiarity index system 30 utilizes interfaces 44 to communicate with external systems, e.g., fraud detection system 15, call routing system 20, IVR systems 22, agent desktop systems 24, account system 26, CRM system 28, initial authentication 17, secondary authentication 19 or transaction system 31 from FIG. 1.

In the illustrated example of FIG. 2, familiarity index system 30 includes an application programming interface (API) 50. Although shown in FIG. 2 as being included in familiarity index system 30, in other examples, familiarity index storage 40 may be maintained externally in one or more of a plurality of databases and other storage facilities accessible via contact center 12. In some examples, familiarity index storage 40 may be encrypted. The type of encryption, the strength of encryption, and encryption channel used to encrypt familiarity index storage 40 may be configurable by one or more administrators of contact center 12.

When a call enters contact center 12, familiarity index system 30 may receive a notification of the inbound call from call routing system 20 or another computing device that performs at least some gateway functions for contact center 12. Such a notification may be received via interfaces 44. In some examples, Familiarity index system 30 utilizes interfaces 44 to communicate with external systems, e.g., fraud detection system 15, call routing system 20, IVR systems 22, agent desktop systems 24, account system 26, CRM system 28, initial authentication 17, secondary authentication 19 or transaction system 31 from FIG. 1.

FIG. 3 is a block diagram illustrating an exemplary comparison using stored familiarity index 302. In the block diagram example of FIG. 3, stored familiarity index 302 includes a number of elements 302A, 302B, and 302C. Call analysis unit 36 of FIGS. 1 and 2 may create derived call values 304, including elements 304A, 304B, and 304C.

The elements 302A, 302B, and 302C of the stored familiarity index 302 may then be compared to elements 304A, 304B, and 304C of derived call values 304 in comparison unit 306. For example, when the elements are embeddings or output values, a similarity measure, such as a Euclidean or other distance measure, a cosine measure or a dot product measure, between embedding or output values may be produced as a comparison. Some comparisons, such as a user device ID comparison, may be a binary match or no match comparison.

The stored familiarity index 302 may have elements not used in a specific comparison. For example, as the derived call values 304 are produced, certain elements are easier to create earlier in the call. For example, call location and user device information might be easily available early on in the call. Analysis of the user's facial expressions and user word choices may take longer. Analysis of the user accent may take an intermediate amount of time.

The weighting unit 308 may weigh the results of the comparison unit 303. The weighting may reflect the importance of the different element comparisons. The determination of the weights may also be developed using machine learning models 38. For example, a machine learning model may be trained using training data from previous calls, including fraudulent calls, to develop appropriate weights. These fraudulent calls may include intentionally spoofed deepfake calls.

After the weighting unit 308, thresholding and decision logic 310 may be used to determine an action concerning a call. Exemplary actions may include blocking the transaction 312, initiating a secondary authentication 314, or allowing the transaction 316. For example, a proposed transaction may be blocked as a result of the automatically evaluating by instructing the agent desktop system 24 or a routing system within the contact center 12 to block or not transmit a transaction request to a transaction system 31 of the bank. Alternately, the proposed transaction may be allowed as a result of the automatically evaluating by instructing an agent desktop system 24 or a routing system within a contact center 12 to transmit a transaction request to a transaction system 31 of the bank.

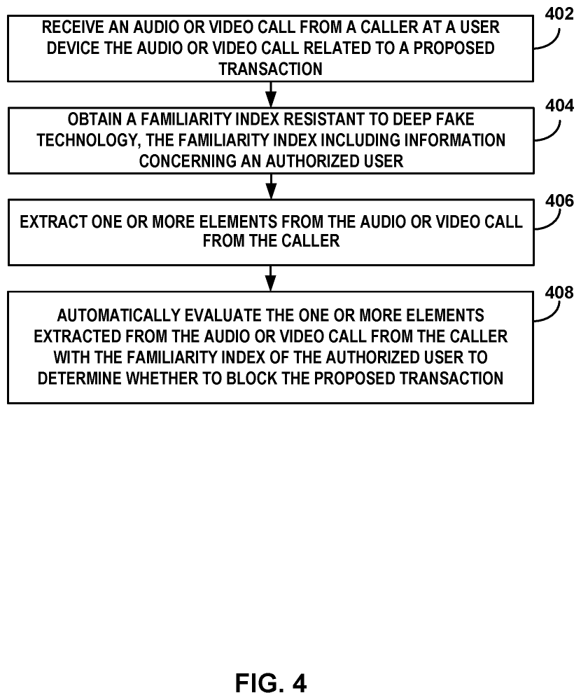

FIG. 4 is a flowchart illustrating an example operation of a computing device, such as familiarity index system 30 of FIGS. 1 and 2, in accordance with the techniques of this disclosure. A computer system receives an audio or video call from a user device; the audio or video call related to a proposed transaction (402). The transaction may be a transfer of funds or payment.

A computer system obtains a familiarity index resistant to deep fake technology; the familiarity index including information concerning an authorized user (404). For example, the familiarity index may be obtained from the familiarity index storage 40.

A computer system extracts one or more elements from the audio or video call (406). As discussed above, extracting the elements from the call may include call analysis using machine learning models. The extracting may include extracting voice accent information of the user or facial expression information of the user using a machine learning model.

A computer system automatically evaluates the one or more elements extracted from the audio or video call from the caller with the familiarity index of the authorized user to determine whether to block the proposed transaction (408). The subject comparison may include operations such as those described with respect to FIG. 3. The evaluating may include matching one or more elements of the audio or video call with the familiarity index. The evaluating may include making a weighted match of the familiarity index with one or more elements of the audio or video call, further comprising comparing the weighted match to a threshold.

In one or more examples, the functions described may be implemented in hardware, software, firmware, or any combination thereof. If implemented in software, the functions may be stored on or transmitted over a computer-readable medium as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
receiving an audio or video call at a computing system from a caller at a user device, wherein the audio or video call is related to a proposed transaction;
performing, at the computing system and using one or more authentication challenges, an initial authentication of the caller as an authorized user;
obtaining, at the computing system, a familiarity index resistant to deep fake technology and unique to the authorized user, wherein the familiarity index includes elements related to the authorized user that are resistant to emulation by the deep fake technology and that are developed based on one or more previous audio or video calls from the authorized user associated with other proposed transactions;
extracting, at the computing system, one or more elements from the audio or video call from the caller that are resistant to emulation by the deep fake technology;
automatically evaluating, at the computing system while the audio or video call from the caller is ongoing and following the initial authentication of the caller, the one or more elements extracted from the audio or video call from the caller with the elements of the familiarity index of the authorized user to determine whether to block or allow the proposed transaction;
based on a result of the evaluation, performing, at the computing system, a secondary authentication of the caller as the authorized user; and
sending, by the computing system, a communication to an agent system or a routing system thereby instructing the agent system or the routing system to one of block or allow transmission of the proposed transaction to a transaction system based on a result of the secondary authentication of the caller as the authorized user.

2. The method of claim 1, further comprising:
authenticating the caller as the authorized user based on the initial authentication; and
generating and storing the familiarity index for the authorized user.

3. The method of claim 1, wherein automatically evaluating includes determining whether the one or more elements extracted from the audio or video call from the caller match the elements of the familiarity index of the authorized user.

4. (canceled)

5. The method of claim 1, wherein sending the communication further comprises sending the communication thereby instructing the agent system or the routing system to block the transmission of the proposed transaction to the transaction system of a bank based on the one or more elements extracted from the audio or video call from the caller not matching the elements of the familiarity index of the authorized user and a subsequent failure of the secondary authentication of the caller as the authorized user.

6. The method of claim 1, wherein sending the communication further comprises sending the communication thereby instructing the agent system or the routing system to allow transmission of the proposed transaction to the transaction system of a bank based on the one or more elements extracted from the audio or video call from the caller matching the elements of the familiarity index of the authorized user or a subsequent successful authentication of the caller as the authorized user based on the secondary authentication.

7. (canceled)

8. The method of claim 1, wherein the audio or video call is a video call.

9. The method of claim 1, further comprising:
receiving, at the computing system, additional calls from multiple additional callers, each additional caller having an individual familiarity index;
extracting, at the computing system, one or more elements from the additional calls from the additional callers, and
automatically evaluating, at the computing system, the one or more elements extracted from the additional calls with elements of the individual familiarity indexes to determine whether to block or allow proposed transactions associated with the additional callers.

10. The method of claim 1, further comprising:
generating, at the computing system, the familiarity index prior to receipt of the audio or video call from the caller, wherein generating the familiarity index comprises developing the elements of the familiarity index using a machine learning model based on the one or more previous audio or video calls from the authorized user associated with the other proposed transactions; and
updating the elements of the familiarity index using the machine learning model after the audio or video call from the caller is terminated.

11. The method of claim 1, wherein extracting the one or more elements from the audio or video call from the caller includes extracting, using a machine learning model, voice accent information of the user or facial expression information of the user from the audio or video call.

12. (canceled)

13. The method of claim 1, wherein automatically evaluating includes calculating a weighted match of the elements of the familiarity index with the one or more elements extracted from the audio or video call from the caller, the method further comprising comparing the weighted match to a threshold.

14. The method of claim 1, further comprising:
initiating, at the computing system, a communication session between the user device and the agent system,
wherein automatically evaluating comprises applying, at the computing system, the elements of the familiarity index to the one or more elements extracted from the audio or video call from the caller during the communication session.

15. A computing system comprising:
a memory; and
one or more processors in communication with the memory and configured to:
receive an audio or video call from a caller at a user device, wherein the audio or video call is related to a proposed transaction;
perform, using one or more authentication challenges, an initial authentication of the caller as an authorized user;
obtain a familiarity index resistant to deep fake technology and unique to the authorized user, wherein the familiarity index includes elements related to the authorized user that are resistant to emulation by the deep fake technology and that are developed based on one or more previous audio or video calls from the authorized user associated with other proposed transactions;
extract one or more elements from the audio or video call from the caller that are resistant to emulation by the deep fake technology;
automatically evaluate, while the audio or video call from the caller is ongoing and following the initial authentication of the caller, the one or more elements extracted from the audio or video call from the caller with the elements of the familiarity index of the authorized user to determine whether to block or allow the proposed transaction;
based on a result of the evaluation, perform a secondary authentication of the caller as the authorized user; and
send a communication to an agent system or a routing system thereby instructing the agent system or the routing system to one of block or allow transmission of the proposed transaction to a transaction system based on a result of the secondary authentication of the caller as the authorized user.

16. The computing system of claim 15, wherein the one or more processors are configured to:
authenticate the caller as the authorized user based on the initial authentication; and
generate produce and store the familiarity index for the authorized user.

17. The computing system of claim 15, wherein to automatically evaluate, the one or more processors are configured to determine whether the one or more features extracted from the audio or video call from the caller match the elements of the familiarity index of the authorized user.

18. (canceled)

19. The computing system of claim 15, wherein to send the communication the one or more processors are further configured to send the communication thereby instructing the agent system or the routing system to block the transmission of the proposed transaction to the transaction system of a bank based on the one or more elements extracted from the audio or video call from the caller not matching the elements of the familiarity index of the authorized user and a subsequent failure of the secondary authentication of the caller as the authorized user.

20. Non-transitory computer readable media comprising instructions that when executed cause one or more processors to:
receive an audio or video call from a caller at a user device, wherein the audio or video call is related to a proposed transaction;
perform, using one or more authentication challenges, an initial authentication of the caller as an authorized user;
obtain a familiarity index resistant to deep fake technology and unique to the authorized user, wherein the familiarity index includes elements related to the authorized user that are resistant to emulation by the deep fake technology and that are developed based on one or more previous audio or video calls from the authorized user associated with other proposed transactions;
extract one or more elements from the audio or video call from the caller that are resistant to emulation by the deep fake technology;
automatically evaluate, while the audio or video call from the caller is ongoing and following the initial authentication of the caller, the one or more elements extracted from the audio or video call from the caller with the elements of the familiarity index of the authorized user to determine whether to block or allow the proposed transaction;
based on a result of the evaluation, perform a secondary authentication of the caller as the authorized user; and
send a communication to an agent system or a routing system thereby instructing the agent system or the routing system to one of block or allow transmission of the proposed transaction to a transaction system based on a result of the secondary authentication of the caller as the authorized user.

21. The method of claim 1, wherein the elements of the familiarity index include word choice of the authorized user, wherein the one or more elements extracted from the audio or video call from the caller include word choice of the caller, and wherein automatically evaluating the one or more elements extracted from the audio or video call from the caller includes matching the word choice of the caller with the word choice of the authorized user included in the familiarity index.

22. The method of claim 1, wherein automatically evaluating the one or more elements extracted from the audio or video call from the caller includes determining a level of scrutiny based on a value of the proposed transaction, and automatically evaluating the one or more elements based on the determined level of scrutiny.

23. The method of claim 1, wherein performing the secondary authentication of the caller includes determining, at the computing system, whether to perform the secondary authentication based on a value of the proposed transaction.

24. The method of claim 1, further comprising initializing the familiarity index using one of:
location data,
user device information, or
information extracted from the one or more previous audio or video calls from the authorized user associated with the other proposed transactions.
